(19) United States
(12) Patent Application Publication
(10) Pub. No.: US 2009/0022974 A1
(43) Pub. Date: Jan. 22, 2009

(54) TREATED ARTICLES AND METHODS OF TREATING ARTICLES

(75) Inventors: Sang Beom Lee, Harrison City, PA (US); Lacramioara Trofin, Monroeville, PA (US); Alan Rae, Wilson, NY (US); Keith Blakely, Buffalo, NY (US)

Correspondence Address: HAHN LOESER & PARKS, LLP, One GOJO Plaza, Suite 300, AKRON, OH, 44311-1076, US

(73) Assignee: NanoDynamics, Inc., Buffalo, NY (US)

(21) Appl. No.: 12/161,965

(22) PCT Filed: Jan. 26, 2007
(86) PCT No.: PCT/US07/61135

§ 371 Date: Jul. 24, 2008

Related U.S. Application Data
(60) Provisional application No. 60/762,742, filed on Jan. 27, 2006.

(51) Int. Cl. B32B 9/04; B32B 3/26; B32B 27/00; B32B 27/38; B32B 27/40; B32B 15/04; B05D 3/02; B05D 3/12; C08F 2/48

(52) U.S. Cl. 428/304.4; 428/411.1; 428/702; 428/500; 428/413; 428/423.1; 428/457; 428/221; 427/385.5; 427/240; 427/508; 977/742

(57) ABSTRACT

Treated articles are provided. The treated articles may have at least one functional particle in a substrate and at least one blocking material. The blocking material inhibits the release of the at least one functional particle from the substrate. Methods of treating articles are further provided.

### CROSS REFERENCE TO RELATED APPLICATION

This application claims priority to and any other benefit of U.S. Provisional Application Ser. No. 60/762,742, filed Jan. 27, 2006, the entirety of which is incorporated by reference herein.

### BACKGROUND

A variety of nanomaterials with unique size, shape and surface properties have been developed for many applications, such as microelectronics, optics and medical devices. One of the unique properties of nanoparticles is their large surface area, which provides more functional space for catalysis and sensing compared with the surface area of bulk materials. Nanoparticles also exhibit unique surface properties due to their surface-to-volume ratio and the presence of quantum effects, such as the electronic and photo-responsive properties of quantum dots.

Nanomaterials themselves, typically being fine powders, do not possess mechanical strength and cannot be formed into useful macro-scale items. In order to maximize the effect of these properties in actual applications, the nanomaterials are often embedded within, dispersed in or coated on conventional materials. By this process, it is possible to form usable macro-scale devices and products, such as catalysts, coatings, electrodes, dielectrics, fabrics, garments and air filters, which are hybrid composites of macro- and nano-scale materials.

Nanoparticles are small and extremely light, and are readily dispersed as aerosols and suspensions. Accordingly, they must be physically attached to or entrapped within the matrix of the macro-scale device or composition, if they are to remain in place and carry out their desired function for an extended period of time. The fixation of nanomaterials in such substrates serves to extend the working lifetime of the products, and also minimizes any unexpected health and environmental problems that the dispersal of free nanoparticles into the environment might present. For these reasons, the stabilization of nanomaterials dispersed in substrates is highly desirable for many practical applications of nanomaterials.

In the last decade, progress in development of new technology has resulted in textiles and other substrates with enhanced and tailored properties for a variety of applications. A broad range of industries, including the automotive, health care, construction, electronics, military equipment and textile industries, require fabrics or other substrates with improved characteristics.

Among the valuable properties that can be imparted to substrates are: (1) improved stability against mechanical, chemical, photochemical or thermal destruction, e.g., for industrial toxic materials, chemical and biological toxic agents, or as flame resistant agents; (2) improved repellency properties against water, oil and soil; (3) altered light absorption and emission properties from the UV up to the IR region; (4) improved electrical conductivity, e.g. for antistatic and electromagnetic protective properties; (5) immobilization and controlled release of active species, such as biocidal and therapeutic substances; and (6) enhanced barrier properties against harmful or noxious substances.

It has been found that nanoparticles may be difficult to retain in or on a substrate, and a variety of approaches have been used to assist in retaining nanoparticles in or on a substrate. For example, nanoparticles can be embedded in polymeric substrates, and retained physically or by covalent bonding. See for example Ramachandran, T. et al. Antimicrobial textiles. An Overview. IE (I) Journal. TX, 2004, 84, 45-51, Gao. J. et al. J. Am. Chem. Soc. 2005, 127, 3847-3854, Sen, R. et al. Nano Lett. 2004, 4, 459-464, Liu, T. et al. Macromolecules 2004, 37, 7214-7222, Gangopadhyay R. et al Chem. Mater. 2000, 12, 608-622, Mayer, A. B. R. et al. Polym. Adv. Technol. 2001, 12, 96-106, Jordan, J. et al. Mater. Sci. Eng. A 2005, 393, 1-11, Lauter-Pasyuk, V. et al. Langmuir 2003, 19, 7783-7788, Svechnikov, S. V. et al. Russian J. Electrochem. 2004, 40, 259-266, Kumar, T. K. et al. Langmuir 2004, 20, 4733-4737, Zhang, J. et al. Chem. Eur. J. 2004, 10, 3531-3536, Wang, P.-C. et al. J. Polym. Sci.: Part A: Polym. Chem. 2004, 42, 5695-5705, Lee, C.-F. et al. J. Polym. Sci.: Part A. Polym. Chem. 2005, 43, 342-354, Nicholson, P. G. et al. Chem. Commun. 2005, 1052-1054, Yuce, M. Y. et al. Langmuir 2005, 21, 5073-5078, Kedem, S. et al. Langmuir 2005, 21, 5600-5604, Zeng, A. et al. J. Polym. Sci.: Part A: Polym. Chem. 2005, 43, 2826-2835, Mallick, K. et al. Mater. Sci. Eng. B 2005, 123, 181-186, Murugaraj, P. et al. J. Appl. Phys. 2005, 98, 054304-1˜6, Zhang, H. et al. Nature Mater. 2005, 4, 787-793, Tang, E. et al. Colloid Polym. Sci. 2006, 284, 422-428, and Zheng, Z. X. et al. Phys. Chem. Comm. 2001, 21, 1-2. See also, for example, US Patent Application 20050229328, U.S. Pat. No. 6,607,994, Eur. Pat. Appl. 1243688 (2002), U.S. Pat. No. 5,641,561, U.S. Pat. No. 6,872,424, U.S. Pat. No. 4,174,418, U.S. Pat. No. 4,199,322, and U.S. Pat. No. 4,394,517.

A common drawback of these approaches is that nanoparticles often lose their desirable functional properties upon covalent binding to the surfaces. Surface properties, such as catalytic, optical, absorption and antimicrobial properties, are also susceptible to being attenuated or eliminated when particles are embedded within polymer matrices. Another approach to attaching nanomaterials to polymer matrices is by physically loading or layering the particles into or onto textiles. This approach has the disadvantage that composites comprised of nanomaterials loosely adsorbed to surfaces are not stable for long periods of time.

Thus, there remains a need in the art for alternative methods of retaining nanomaterials and other functional particles on or in substrates.

### SUMMARY

In accordance with embodiments of the present invention, treated articles are provided. The treated articles may comprise a substrate, at least one functional particle in the substrate, and a blocking material comprising at least one polymer formed from self-assembling monomers. The blocking material inhibits release of the at least one functional particle from the substrate, and the blocking material is disposed on at least a portion of at least one surface of the substrate.

In accordance with other embodiments, methods for treating articles are provided. The methods can comprise providing a substrate having at least one functional particle; treating the substrate with self-assembling monomers; and polymerizing the self-assembling monomers such that release of the at least one functional particle from the substrate is inhibited.

It will be understood that these and other embodiments are included in the scope of the present invention.

### BRIEF DESCRIPTION OF THE SEVERAL VIEWS OF THE DRAWINGS

The following detailed description of embodiments of the present invention can be best understood when read in conjunction with the following drawings, where like structure is indicated with like reference numerals and in which:

FIG. 1 shows a schematic representation of a treated article;

FIG. 2 shows a schematic representation of another treated article;

FIG. 3 shows textiles embedded with carbon black before and after a washing process; A is a carbon black textile with diacetylenes used as blocking materials, and B is the carbon black textile without blocking materials;

FIG. 4 shows textiles embedded with titanium dioxide (TiO₂) nanoparticles before and after a washing process; A is a TiO₂ textile with diacetylenes used as blocking materials, and B is a TiO₂ textile without blocking material;

FIG. 5 shows the antibacterial efficiency of a silver nanoparticle textile; and

FIG. 6 shows the sporicidal efficiency of a silver nanoparticle textile.

### DETAILED DESCRIPTION OF EMBODIMENTS OF THE INVENTION

The present invention will now be described with occasional reference to the specific embodiments of the invention. This invention may, however, be embodied in different forms and should not be construed as limited to the embodiments set forth herein. Rather, these embodiments are provided so that this disclosure will be thorough and complete.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used ill the description of the invention and the appended claims, the singular forms “a,” “an,” and “the” are intended to include the plural forms as well, unless the context clearly indicates otherwise. All publications, patent applications, patents, and other references mentioned herein are incorporated by reference in their entirety.

Unless otherwise indicated, all numbers expressing quantities of ingredients, properties such as molecular weight, reaction conditions, and so forth as used in the specification and claims are to be understood as being modified in all instances by the term “about.” Accordingly, unless otherwise indicated, the numerical properties set forth in the following specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

In accordance with embodiments of the present invention, treated articles are provided. In accordance with other embodiments of the present invention, methods of treating articles are provided.

In some embodiments, treated articles are provided. The treated articles comprise a substrate, at least one functional particle in the substrate, and a blocking material comprising at least one polymer formed from self assembling monomers. The blocking material inhibits release of the at least one functional particle from the substrate. The blocking material may be disposed on at least a portion of at least one surface of the substrate.

For purposes of describing and defining the present invention, the term “in the substrate” shall be understood as referring to a functional particle that is on or in the substrate. Further, for purposes of describing and defining the present invention, the term “inhibits release” shall be understood as meaning the functional particles being retained in the substrate for a period of time under normal usage conditions that is greater than the period of time that the particles are retained in the substrate in the absence of the blocking material. Thus, the blocking materials may inhibit the release of or the leaching of functional particles from the substrate. Additionally, for purposes of describing and defining the present invention, the term “disposed on at least a portion of at least one surface of the substrate” shall be understood as meaning a polymer disposed on or in at least a portion of at least one surface of the substrate, including a polymer coating, a polymer reacted with a substrate, and a polymer interwoven or intertwined with a substrate.

The substrate may be any suitable substrate. For example, the substrate may be fibers, yarns, porous and non-porous textiles, membranes, metals, and natural and synthetic polymers, and combinations thereof. In some examples, the substrate may be a porous substrate. In other examples, the substrate may be a woven or non-woven textile formed from natural or synthetic components. It will be understood that the substrate may be of any suitable size and shape. It will be further understood that the functional particle or particles may be provided on or in any portion or portions of the substrate. It will also be understood that the blocking material may be provided on or in any portion or portions of the substrate.

Any suitable functional particle may be used. For purposes of defining and describing the present invention, the term “functional particle” shall be understood as referring to a moiety that functions in any desired manner in a substrate. For example, functional particles may be nanoparticles, microparticles, or macro-sized particles. In some examples, the functional particles may be at least one nanoparticle selected from carbon nanotubes, TiO₂, Ag, carbon black, ZrO₂, MgO, SiO₂, ZnO, Al₂O₃, N₂O₅, WO₃, Ta₂O₅, HfO₂, SnO₂, SiAlO_{3.5}, SiTiO₄, ZrTiO₄, Al₂TiO₅, ZrW₂O₈, CaCO₃, MoO₃, Mo, V₂O₅, Sb₂O₅, Pd, ZnO, Fe₃O₄, Kaolin, Sulfur, CoFe₂O₄, Au, Pt, Cu, Ni, quantum dots, halloysites, inorganic nanomaterials, organic nanomaterials, and naturally occurring nanomaterials, and combinations thereof. In other examples, the functional particles may be selected from activated carbon, fabric softeners, thermochromic materials, magnetic particles, reflective particles, fire retardants, fire suppressant chemicals, insect repellents, electromagnetic interference shielding materials, radio frequency interference shielding materials, heat-releasing phase change agents, fragrances, metallic reflector colloids, pigments, zeolites, dyes, fertilizers, sun blocking agents, pharmaceuticals, antimicrobial agents, anti-fungal agents, and sporicidal agents, and combinations thereof.

Functional particles such as those listed above can be unmodified or can be modified with functional groups, including but not limited to, amino-, carboxy-, and alkyl-silanes and amino-, carboxy-, and alkyl-thiols, or biochemicals such as proteins, nucleic acids, carbohydrates. In addition, the functional particles can be modified with molecular receptors, to sense outside chemical or biological compounds.

It will be understood that more than one type of functional particle may be selected to provide a substrate having desired properties. For example, silver particles may be chosen to provide an antibacterial or sporicidal effect and TiO₂ particles may be chosen to provide a sun protection effect.

The functional particle or particles may be provided in any suitable concentration. One having skill in the art will be able to select a suitable concentration depending on the type of substrate, desired application, and desired effect of the functional particle in the treated article.

Any suitable self-assembling monomers may be selected to form the blocking material. For purposes of defining and describing the present invention, the term “self-assembling monomers” shall be understood as referring to moieties that self-assemble to form monolayers or structures and that may be polymerized. A variety of self-assembling monomers are available and known to those skilled in the art. For example, suitable self-assembling monomers include, but are not limited to, lipids, diacetylene derivatives, monomers for forming conjugated polymers, alkyl trichlorosilane derivatives, alkyl trialkoxysilane derivates, liquid crystalline monomers, 3-(trimethoxysilyl)-1-propanethiol, thiols, vinyl monomers, epoxides, lignins, dienes, eneynes, pyrolles, thiphenes, pyrazoles, urethanes, imides, acrylonitriles, alkynes, anthracenes, stilbenes, and cationic, anionic and neutral surfactants, monomers for liquid crystalline polymers, and combinations thereof.

In some examples, the self-assembling monomers may be diacetylene monomers. For example, lipid diacetylenes may be used. One such self-assembling diacetylene monomer is 10,12-pentacosadiynoic acid. In some examples, the lipid diacetylenes may exhibit polymerization behavior whereby they do not readily polymerize until they self-assemble into organized nanostructures, such as nanocrystals or nanotubules. Once so assembled and properly aligned, they are readily polymerized by UV (254 nm) or γ-ray irradiation (Patel, G. N. et al. J. Am. Chem. Soc., 1978, 100, 6644-6649, Bloor, D. et al. Martinus Nijhoff Publishers: Boston, 1985, Alekseev, A. S. et al. Langmuir, 2000, 16, 3337-3344, Huggins, H. E. et al. Macromolecules, 1997, 30, 5305-5312. Okada, S. et al. Acc. Chem. Res. 1998, 31, 229-239). In addition, the polymerized forms may exhibit characteristic colors, such as blue, orange or red, depending on the monomer structures. Thus, the observation of a color may be a good indication of self-assembly and polymerization. Furthermore, upon exposure of polydiacetylene nanostructures to environmental changes that alter the overlap of adjacent π-orbitals, these polymers can undergo dramatic color transitions, for example from deep blue to bright red. Stimuli capable of inducing such changes include pH, temperature, mechanical stress, and the binding of ligands such as small molecules, toxins, viruses and bacteria. This chromism is being used in many applications, such as biosensors, optics, and micro electronics.

The self-assembling monomers may self-assemble to form any suitable structure on or in the substrate. For example, nanocrystals, nanotubes, lamellae, and micelles may be formed by the self-assembling monomers. The self-assembling monomers are polymerized to form the blocking materials. In some examples, the self-assembling monomers contain groups that may be reactive with the substrate either before or after polymerization. For example, diacetylene monomers may contain groups that are reactive with textile fibers. In other examples, functional groups that may be reactive with the substrate are provided.

In some examples, the blocking materials may comprise conjugated polymers selected from lipid poly(diacetylene) derivatives, poly(p-phenylene vinylene), polyanilines, natural and synthetic vinyl polymers, and combinations thereof.

In some examples, the polymeric blocking materials may further have any suitable functional groups. For example, the polymer may have functional groups such as amines, carboxylic acid, N-hydroxy succinimide, isocyanates, hydroxyl groups, and combinations thereof. These functional groups may be reactive with certain components of the substrate. For example, the functional groups may be reactive with components of natural or synthetic textiles. In other examples, functional groups may comprise biochemicals such as proteins, nucleic acids, carbohydrates. In yet further examples, the functional groups may be molecular receptors to sense outside chemical or biological compounds. In some examples, the blocking materials have reactive chemical groups on their surfaces which do not react with the surface of the functional particles, but do react with a variety of organic substrates, such as the aromatic rings in polyesters and polystyrene, amino groups in wool and leather, and the hydroxyl groups in cotton and paper. In other examples, the blocking materials have reactive chemical groups on their surfaces that may react with polymer substrates.

The blocking materials may function in any suitable manner to inhibit release of functional particles from the substrate. The blocking materials may function as a physical barrier to the functional particles. For example, the blocking materials may form conjugated backbones in or on the substrate that may inhibit release of the functional particles. In other instances, the blocking materials may have functional groups that may be bound to other groups in or on the substrate. Thus, the polymerized blocking materials may be bound to the substrate, and the functional particles may be inhibited from release in this manner. It will be understood that the polymerized blocking materials may comprise a layer or layers on or in the substrate. In other examples, the polymerized blocking materials may comprise polymers that are interwoven with a portion or portions of the substrate. In yet other examples, the polymerized blocking materials may be reacted with a portion or portions of the substrate.

The blocking materials may be present in or on the substrate in any suitable amount. For example, the polymerized self-assembling monomers may comprise between about 0.1% to about 20% by weight of the treated substrate. It will be understood that one having skill in the art will be able to select a suitable amount of the blocking material depending on the application.

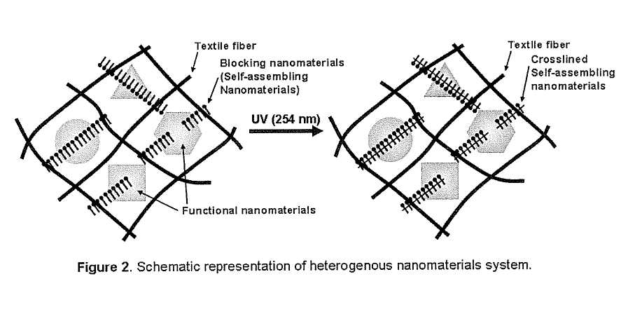

FIG. 2 illustrates one example of a treated article in accordance with embodiments of the present invention. FIG. 2 shows a textile having functional nanoparticles therein. The textile further has a blocking material comprising a blocking nanomaterial formed from polymerized diacetylene monomers that form conjugated backbones.

In accordance with further embodiments of the present invention, methods for treating articles are provided. The methods comprise providing a substrate having at least one functional particle, treating the substrate with self-assembling monomers, and polymerizing the self-assembling monomers to form a blocking material. The blocking material is disposed such that release of the at least one functional particle from the substrate is inhibited. The substrates, self-assembling monomers, and blocking materials may be those discussed above.

The at least one functional particle may be provided in or on the substrate in any suitable manner. For example, the at least one functional particle may be applied by spin coating, dip coating, flow coating, spray coating, and combinations thereof. In one example, the substrate may be immersed in a dipping solution comprising functional particles suspended in water, hexane, dichloromethane, chloroform, tetrahydrofuran, benzene, toluene, or other suitable solvents. In some examples, the functional particles may have a concentration in the dipping solution between 0.001% and 50% by weight. In some embodiments, the substrate is allowed to dry before further processing.

The substrate may be treated with self-assembling monomers in any suitable manner. For example, the substrate may be treated by applying a solution of a self-assembling monomer to the substrate. In some examples, the self-assembling monomer solution may be applied to the substrate is by spin coating, dip coating, flow coating, spray coating, and combinations thereof. In some examples, the substrate may be immersed in a dipping solution containing the self-assembling monomer or monomers. In yet other examples, the substrate may be allowed to dry after being treated with the self assembling monomers. In one example, a substrate containing functional particles is dipped in a solution of a self-assembling monomer, e.g. 10,12-pentacosadiynoic acid. The textile, covered with diacetylene monomers, is allowed to dry slowly. The evaporation process allows the diacetylenes to self-assemble into nanostructures, such as lamellae or tubular structures. Polymerization is subsequently performed. For example, UV irradiation may be performed to polymerize the diacetylene monomers.

The polymerization may be performed in any suitable manner. For example, the step of polymerizing may be performed by at least one of drying, heating, UV curing, and radiation curing of the substrate having the self-assembling monomer thereon. The particular polymerization step is chosen to be performed in a manner and for an amount of time sufficient to allow crosslinking of the self-assembling monomers to any desired extent. It will be understood that the self-assembling monomers may be reactive with the particular substrate selected, and that the reaction with the substrate may occur during the step of polymerization, as discussed above. For example, diacetylene monomers may react with textile fibers during UV polymerization. It will be understood, however, that the self-assembling monomers do not necessarily need to react with or be modified to react with the substrate. In some instances, the self-assembling monomers may be polymerized, and the polymerized blocking materials may be embedded in or on the substrate sufficiently to inhibit the release of functional particles from the substrate.

In some examples, the type of polymerization avoids some wet chemical processes that may have a deleterious effect on functional particles. In other examples, the methods may prevent the functional particles from being adversely effected or reacted, such that the functional particles may maintain their function in the treated article.

In some alternate embodiments of the present invention, the blocking material may be formed from nanomaterials having substrate reactive functional groups. The nanomaterials may be any of the functional particles discussed above. The blocking nanomaterials are generally modified to have substrate reactive functional groups. Any suitable substrate functional groups may be used. In some instances, the blocking nanomaterials may be polymerized. In other cases, the blocking nanomaterials are not polymerized.

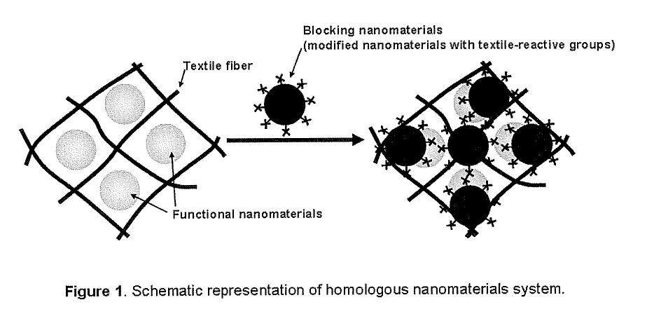

FIG. 1 illustrates an example of a textile having functional particles in the form of functional nanomaterials and blocking materials in the form of nanoparticles having textile reactive groups. For example, unmodified silver nanoparticles can be embedded in a textile as functional nanoparticles, conferring their antimicrobial properties to the textile; see for example U.S. Pat. No. 6,979,491 and references therein. Silver nanoparticles that have been modified with one or more reactive functional groups are then embedded into the textile as blocking nanomaterials, under conditions such that the reactive functional groups covalently bind the blocking nanomaterials to the textile. The final composite will have antimicrobial properties, due to the unmodified Ag nanoparticles added as functional nanoparticles. The blocking nanomaterials (Ag nanoparticles) that were modified with textile-reactive groups may or may not have retained antimicrobial properties, but their primary function in the invention is to react with and bond to the textiles. In this way, the modified Ag nanoparticles will block and inhibit the release of unmodified Ag nanoparticles out off the textiles.

In another example, a textile-nanoparticles composite is prepared by embedding unmodified TiO₂ nanoparticles into a textile, followed by Ag nanoparticles modified with textile-reactive groups. In this system, the TiO₂ nanoparticles are functional particles having photocatalytic properties. The modified Ag nanoparticles are blocking nanomaterials which inhibit leaching of the TiO₂ from the textiles. It will be understood that any suitable functional particles and blocking materials may be used.

In some examples, the blocking nanomaterials have reactive chemical groups on their surfaces which do not react with the surface of the functional particles, but do react with a variety of organic substrates, such as the aromatic rings in polyesters and polystyrene, amino groups in wool and leather, and the hydroxyl groups in cotton and paper. In other examples, the blocking nanomaterials have reactive chemical groups on their surfaces that may react with polymer substrates.

The nanoparticles having substrate reactive groups may be applied to the substrate in any suitable manner and in any suitable amount. For example, the nanoparticles having substrate reactive groups may be applied to the substrate by spin coating, dip coating, flow coating, and spray coating a solution containing the nanoparticles to the substrate. The substrate having the nanoparticles with substrate reactive groups may be further treated in any suitable manner. For example, the substrate may be dried or heated. In yet another example, the substrate may be subjected to radiation, such as UV radiation, to crosslink the nanoparticles having the substrate reactive groups. In some examples, the functional particles are first applied to the substrate and the nanoparticles having substrate reactive groups are subsequently applied to the substrate. It will be understood that the methods discussed above with respect to self-assembling monomers may be adapted to provide methods of treating articles using nanoparticles having substrate reactive groups.

In some examples, the nanoparticles having substrate reactive groups physically block the functional particles from being released from the substrate. It will be understood that the nanoparticles having substrate reactive groups may be further modified with any of the functional groups as discussed above in connection with the functional particles.

In the embodiments of the present invention, functional particles on substrates may have preserved or even enhanced their functions. In addition, functional particles may be inhibited from being released from the substrates. This may allow the substrates to be used for longer periods of time or with increased efficacy over untreated substrates. It will be understood that the treated articles may be used for any suitable purpose. For example, treated articles may be used as wound dressings, shielding materials, personal protective masks, military garments, self-cleaning materials, or self decontaminating materials. It is understood that these examples only illustrate some of the potential uses for the treated articles and methods of treating articles.

The present invention will be better understood by reference to the following examples which are offered by way of illustration not limitation.

### EXAMPLES

### Example 1

### Stabilized Carbon Black Nanoparticles in Textiles

Activated carbon itself or carbon beads are the main active component in military garments for decontamination of chemical warfare agents (CWA), because they can absorb substantial amounts of volatile organic chemicals and their vapors. Despite the superior absorption capacity of activated carbon, options for effective use of the material are limited because carbon is basically an inert material, and it is difficult to chemically modify the surface. Without chemical bonding between the activated carbon and textile, textile/activated carbon composites tend to release activated carbon over time, which can lead to skin irritation, skin darkening and respiratory problems. Methods for the stabilization of activated carbon particles in textiles are therefore of considerable interest.

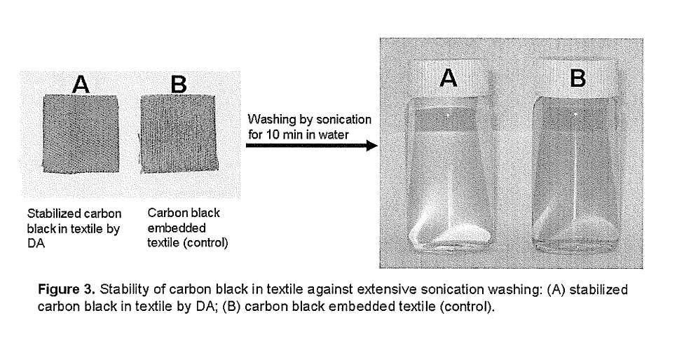

In this example, a textile sample (68% polyester, 32% cotton) was cut into small pieces (2.5 cm×2.5 cm). The textile pieces were placed in a suspension of 20 mg of carbon black (Darco® G-60, ˜100 mesh, Aldrich) in 20 ml of hexane, and sonicated at room temperature for 5 min to form a textile/carbon black composite. After drying the textile in a vacuum oven at 25° C. for 12 h, it was dipped in a solution of 10 mg of 10,12-pentacosadiynoic acid in 20 ml of dichloromethane for 10 seconds. Diacetylene nanocrystals were formed by drying the fabric in a vacuum oven at 25° C. for 12 h. The dried textile was then polymerized in a UV-crosslinker (254 nm) for 1 min. For the stability test, both a textile/carbon black composite stabilized by diacetylene nanocrystals and an unstabilized textile/carbon black as a control were placed in 20 ml of water, and sonicated for 10 min to simulate washing conditions likely to cause the release of carbon black from the textiles. As seen in FIG. 3A, a textile-carbon black composite stabilized by diacetylene nanocrystals did not visibly release carbon black particles during the sonication, while the untreated textile-carbon black composite (FIG. 3B) released visible quantities of carbon black. This result indicates that polymerized diacetylene nanocrystals impede the leaching of carbon black from textiles.

### Example 2

### Preparation and Testing of Stabilized TiO₂ Nanoparticles-Textiles

The polymerization of diacetylene nanocrystals, having been shown to contribute to the stabilization of carbon black in textiles, was next applied to TiO₂ nanoparticles. Degussa P25 TiO₂ nanoparticles are approximately 21 nm in diameter and very hydrophilic due to the hydrolyzed TiO₂ surface. Because of the hydrophilic nature of these TiO₂ nanoparticles, retaining them in a textile against a water wash is more difficult than retaining carbon black.

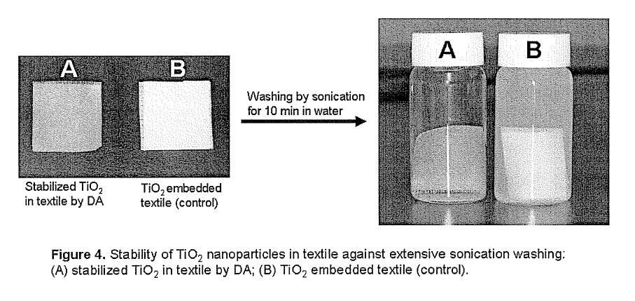

A small textile piece (2.5 cm×2.5 cm) was placed in a suspension of 20 mg of TiO₂ in 20 ml of hexane, followed by sonication at room temperature for 5 min to form a textile/TiO₂ composite. After drying the textile in a vacuum oven at 25° C. for 12 h, it was dipped in a solution of 10 mg of 10,12-pentacosadiynoic acid in 20 ml of dichloromethane for 10 sec, followed by drying in a vacuum oven at 25° C. for 12 hr, to form diacetylene nanocrystals. The dried textile then was polymerized in a UV-crosslinker (254 nm) for 1 min. For the stability test, both a textile/TiO₂ composite stabilized by diacetylene nanocrystals, and an unstabilized textile/TiO₂ swatch as a control, were placed in 20 ml of water and then sonicated for 10 min to stimulate the release of TiO₂ nanoparticles from the textiles. There was a difference between diacetylene nanocrystal-treated and untreated textiles, as seen in FIG. 4.

### Example 3

### Textiles with Stabilized Silver Nanoparticles

Textile swatches (68% polyester, 32% cotton) were cut into small pieces (2.5 cm×2.5 cm). The textile pieces were placed in a suspension of 20 mg of silver nanoparticles (NanoDynamics™ S2-80 Ag nanoparticles) in 20 ml of hexane, followed by sonication at room temperature for 5 min to form the textile-Ag composite. After drying the textile in a vacuum oven at 25° C. for 12 h, it was dipped in a solution of 10 mg of 10,12-pentacosadiynoic acid in 20 ml of dichloromethane for 10 sec, followed by drying in a vacuum oven at 25° C. for 12 h for the formation of diacetylene nanocrystals. The dried textile was then polymerized in a UV-crosslinker (254 nm) for 1 min. Textile/Ag composites, both coated with diacetylene nanocrystals and uncoated, were placed in 20 ml of water and sonicated for 10 min.

Table 1 shows the results of stabilization by diacetylene (DA) nanocrystals of textiles containing different nanoparticles. There were clear differences between treated and untreated textiles. Polymerized DA nanocrystals inhibited the release of nanoparticles from textiles; a textile-carbon black composite treated with DA nanocrystals lost just 18% of carbon black after sonication, whereas the untreated control lost up to 96% of its load of carbon black. Textiles containing TiO₂ and Ag nanoparticles also showed improved stability with DA treatment.

TABLE 1
Weight change of textile-nanoparticle composites after washing process

| | Carbon | | TiO₂ | | Silver | |
|---|---|---|---|---|---|---|
| | (Darco ™-60) | | (Degussa ™ P25) | | (S2-80) | |
| | with | without | with | without | with | without |
| | treatment* | treatment | treatment | treatment | treatment | treatment |
| textile blank** | 153 | 148 | 150 | 151 | 147 | 151 |
| textile with | 156 | 151 | 153 | 155 | 152 | 157 |
| nanoparticles | | | | | | |
| after adding | 156 | | 153 | | 152 | |
| diacetylene | | | | | | |
| after 10 min | 156 | 148 | 152 | 152 | 150 | 153 |
| sonication | | | | | | |
| loss of | 18% | 96% | 45% | 86% | 37% | 65% |
| nanoparticles | | | | | | |

*Treatment is immersion in diacetylene monomer solution, followed by drying and UV irradiation.
**Mass of samples in mg.

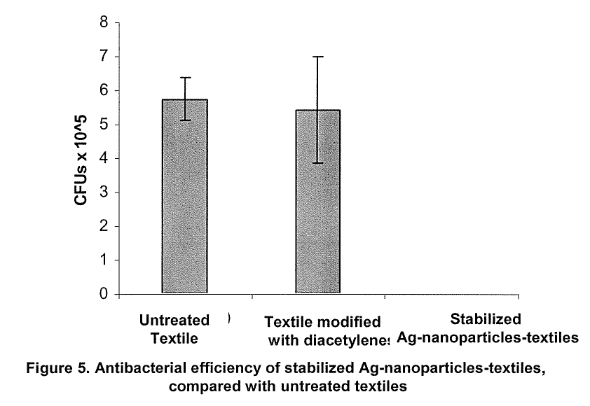

Antibacterial testing was conducted according to Lee, S. B. et al., “Permanent, Nonleaching Antibacterial Surfaces 1. Synthesis by Atom Transfer Radical Polymerization”, Biomacromolecules, 5:877-882 (2004). The number of surviving bacterial cells was determined as colony forming units (CFUs). The stabilized textile-Ag nanoparticle composite killed 100% of the E. coli cells within 1 hour, as seen in FIG. 5. Moreover, after 1 h, the bacterial cell culture solution was clear, which shows that neither Ag nanoparticles nor other materials were released from the textile. This result shows that polydiacetylene nanocrystals do not inhibit the efficacy of Ag nanoparticles against E. coli, as the stabilized textile-Ag nanoparticles composites kill 100% of E. coli cells. In addition, the contact angle of the textile-Ag composite was 136°, which suggests that the textile-Ag composite has the potential for self-cleaning.

### Example 4

### Preparation and Testing of Stabilized Silver Nanoparticles-Textiles

### Sporicidal Efficiency

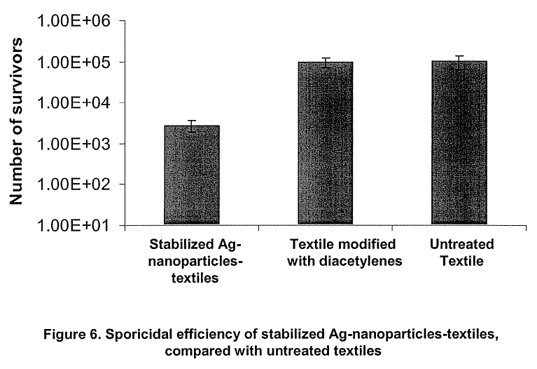

To remove any unstabilized Ag nanoparticles from the textiles, a sample of textile-Ag composite coated with diacetylene nanocrystals was placed in 20 ml of water and then sonicated for 10 min. Sporicidal testing was performed with spores of Bacillus cereus, using a modified ASTM standard, E2149-01 Standard Test Method for Determining the Antimicrobial Activity of Immobilized Antimicrobial Agents Under Dynamic Contact Conditions. A suspension of B. cereus spores was prepared and the number of viable spores adjusted to 10⁸ spores/ml in a buffer containing 0.3 mM KH₂PO₄ and 0.05% Tween 20. The spore suspension was stored under refrigeration and freshly diluted at the time of use in Sorensen's Phosphate Buffer (pH 6.8, 0.3 mM KH₂PO₄). The actual number of spores used for a given experiment was determined by standard serial dilution. Nanoparticle-diacetylene modified textiles were weighed and incubated with 2 mL, of spore suspension in a 15 mL, conical tube (Falcon) at 37° C. and 300 rpm for 12 hours. Then, samples were taken, serially diluted and plated on nutrient agar plates. After 12 hours incubation, the number of surviving spores was determined as colony forming units (CFU) after overnight incubation of the plates at 37° C. After that the number of surviving colonies was counted. The results are shown in FIG. 6. There is a two order of magnitude drop in the number of surviving colonies for the stabilized silver nanoparticles-textiles, compared to the blank textiles. This translates to a 99.9% efficiency.

### Example 5

### Stabilized Carbon Nanotube Textile Composites

Textiles (68% polyester, 32% cotton) were cut into small pieces (2.5 cm×2.5 cm). The textile piece was placed in a solution of 20 mg of carbon nanotubes in 20 ml of toluene, followed by sonication at room temperature for 60 min to make a textile-carbon nanotube composite. After drying the textile in a vacuum oven at 25° C. for 12 h, it was dipped in a solution of 10 mg of 10,12-pentacosadiynoic acid in 20 ml of dichloromethane for 10 sec, followed by drying for the formation of diacetylene nanocrystals in a vacuum oven at 25° C. for 12 h. The dried textile then was polymerized in a UV-crosslinker (254 nm) for 1 min. To remove any unstabilized carbon nanotubes from the textiles, a textile-carbon nanotube composite coated with diacetylene nanocrystals was placed in 20 ml of water and then sonicated for 10 min.

### Example 6

### Stabilized Halloysites-Textiles

Halloysites are naturally occurring nanomaterials. They are ultra-tiny hollow tubes with diameters typically smaller than 100 nm, with lengths typically ranging from about 500 nm to over 1.2 microns. Halloysites are composed of aluminum, silicon, hydrogen, and oxygen and are formed naturally in the earth by surface weathering of aluminosilicate minerals.

Textiles (68% polyester, 32% cotton) were cut into small pieces (2.5 cm×2.5 cm). The textile piece was placed in a suspension of 20 mg of halloysites in 20 ml of hexane, followed by sonication at room temperature for 5 min to form the textile-halloysite composite. After drying the textile in a vacuum oven at 25° C. for 12 h, it was dipped in a solution of 10 mg of 10,12-pentacosadiynoic acid in 20 ml of dichloromethane for 10 sec, followed by drying in a vacuum oven at 25° C. for 12 h. The dried textile then was polymerized in a UV-crosslinker (254 nm) for 1 min. To remove any un-stabilized halloysites from the textiles, a textile-halloysite composite coated with diacetylene nanocrystals was placed in 20 ml of water and then sonicated for 10 min. Three duplicates (sample 1, 2 and 3) were prepared for each textile. All the textiles were weighed before loading the Halloysites, after adding the diacetylenes and after the washing process. The washing process consisted of sonication in water for 10 min. The results are shown in Table 2.

TABLE 2
Weight change of halloysite-textile composites

| | Sample 1 | | Sample 2 | | Sample 3 | |
|---|---|---|---|---|---|---|
| | With | Without | With | Without | With | Without |
| Weight, mg | diacetylenes | diacetylenes | diacetylenes | diacetylenes | diacetylenes | diacetylenes |
| Blank textile | 0.1657 | 0.1533 | 0.1652 | 0.1584 | 0.1733 | 0.1627 |
| After adding | 0.1855 | 0.1718 | 0.18 | 0.1763 | 0.188 | 0.1803 |
| halloysites | | | | | | |
| After adding | 0.186 | | 0.1807 | | 0.1901 | |
| diacetylenes | | | | | | |
| After washing | 0.1809 | 0.1593 | 0.1756 | 0.1632 | 0.1843 | 0.1709 |
| process | (23.2% loss) | (67.5% loss) | (29.7% loss) | (73.2% loss) | (25.2% loss) | (53.4% loss) |

The results in Table 2 show indicate that the Halloysites are stabilized by polymerization of diacetylenes into the textiles. While the textiles embedded with Halloysites lost in average 65% of the incorporated Halloysites, the textiles embedded with Halloysites and stabilized with the polydiacetylenes lost only 26%.

The present invention should not be considered limited to the specific examples described above, but rather should be understood to cover all aspects of the invention. Various modifications, equivalent processes, as well as numerous structures and devices to which the present invention may be applicable will be readily apparent to those of skill in the art.

What is claimed is:

1. A treated article, comprising:
a substrate;
at least one functional particle in the substrate; and
a blocking material comprising at least one polymer formed from self-assembling monomers, wherein the blocking material inhibits release of the at least one functional particle from the substrate, and wherein the blocking material is disposed on at least a portion of at least one surface of the substrate.

2. The treated article as claimed in claim 1 wherein the at least one functional particle comprises at least one nanoparticle comprising carbon nanotubes, TiO₂, Ag, carbon black, ZrO₂, MgO, SiO₂, ZnO, Al₂O₃, Nb₂O₅, WO₃, Ta₂O₅, HfO₂, SnO₂, SiAlO_{3.5}, SiTiO₄, ZrTiO₄, Al₂TiO₅, ZrW₂O₈, CaCO₃, MoO₃, Mo, V₂O₅, Sb₂O₅, Pd, ZnO, Fe₃O₄, Kaolin, Sulfur, CoFe₂O₄, Au, Pt, Cu, Ni, quantum dots, halloysites, inorganic nanomaterials, organic nanomaterials, and naturally occurring nanomaterials, or combinations thereof.

3. The treated article as claimed in claim 1 wherein the at least one functional particle comprises activated carbon, fabric softeners, thermochromic materials, magnetic particles, reflective particles, fire retardants, fire suppressant chemicals, insect repellents, electromagnetic interference shielding materials, radio frequency interference shielding materials, heat-releasing phase change agents, fragrances, metallic reflector colloids, pigments, zeolites, dyes, fertilizers, sun blocking agents, pharmaceuticals, antimicrobial agents, anti-fungal agents, and sporicidal agents, or combinations thereof.

4. The treated article as claimed in claim 1 wherein the self-assembling monomers comprises lipids, diacetylene derivatives, monomers for forming conjugated polymers, alkyl trichlorosilane derivatives, alkyl trialkoxysilane derivates, liquid crystalline monomers, 3-(trimethoxysilyl)-1-propanethiol, thiols, vinyl monomers, epoxides, lignins, dienes, eneynes, pyrolles, thiphenes, pyrazoles, urethanes, imides, acrylonitriles, alkynes, anthracenes, stilbenes, and cationic, anionic and neutral surfactants, monomers for liquid crystalline polymers, or combinations thereof.

5. The treated article as claimed in claim 1 wherein the self-assembling monomers comprise diacetylene monomers.

6. The treated article as claimed in claim 1 wherein the polymer comprises a conjugated polymer selected from lipid poly(diacetylene) derivatives, poly(p-phenylene vinylene), polyanilines, natural and synthetic vinyl polymers, or combinations thereof.

7. The treated article as claimed in claim 1 wherein the polymer further comprises functional groups selected from amines, carboxylic acid, N-hydroxy succinimide, isocyanates, hydroxyl groups, or combinations thereof.

8. The treated article as claimed in claim 1 wherein the substrate is selected from fibers, yarns, porous and non-porous textiles, membranes, metals, and natural and synthetic polymers, or combinations thereof.

9. The treated article as claimed in claim 1 wherein the blocking material comprises a nanomaterial.

10. The treated article as claimed in claim 1 wherein the substrate comprises a textile and the self-assembling monomer comprises a diacetylene.

11. The treated article as claimed in claim 10 wherein the diacetylene comprises 10,12-pentacosadiynoic acid.

12. A method for treating articles, comprising:
providing a substrate having at least one functional particle;
treating the substrate with self-assembling monomers; and
polymerizing the self-assembling monomers such that release of the at least one functional particle from the substrate is inhibited.

13. The method as claimed in claim 12, wherein the step of treating the substrate comprises applying a solution of a self-assembling monomer to the substrate.

14. The method as claimed in claim 13, wherein the step of applying a solution of self-assembling monomer to the substrate is performed by spin coating, dip coating, flow coating, spray coating, or combinations thereof.

15. The method as claimed in claim 12, wherein the step of polymerizing is performed by at least one of drying, heating, UV curing, and radiation curing of the substrate having the self-assembling monomer thereon.

16. The method as claimed in claim 12, wherein the step of treating the substrate comprises treating the substrate with self-assembling monomers comprising lipids, diacetylene derivatives, monomers for forming conjugated polymers, alkyl trichlorosilane derivatives, alkyl trialkoxysilane derivates, liquid crystalline monomers, 3-(trimethoxysilyl)-1-propanethiol, thiols, vinyl monomers, epoxides, lignins, dienes, eneynes, pyrolles, thiphenes, pyrazoles, urethanes, imides, acrylonitriles, alkynes, anthracenes, stilbenes, and cationic, anionic and neutral surfactants, monomers for liquid crystalline polymers, or combinations thereof.

17. The method as claimed in claim 12, wherein the step of providing a substrate comprises providing a substrate having at least one functional particle comprising carbon nanotubes, TiO₂, Ag, carbon black, ZrO₂, MgO, SiO₂, ZnO, Al₂O₃, Nb₂O₅, WO₃, Ta₂O₅, HfO₂, SnO₂, SiAlO_{3.5}, SiTiO₄, ZrTiO₄, Al₂TiO₅, ZrW₂O₈, CaCO₃, MoO₃, Mo, V₂O₅, Sb₂O₅, Pd, ZnO, Fe₃O₄, Kaolin, Sulfur, CoFe₂O₄, Au, Pt, Cu, Ni, quantum dots, halloysites, inorganic nanomaterials, organic nanomaterials, and naturally occurring nanomaterials, or combinations thereof.

18. The method as claimed in claim 12, wherein the step of providing a substrate comprises providing a substrate having at least one functional particle comprising activated carbon, fabric softeners, thermochromic materials, magnetic particles, reflective particles, fire retardants, fire suppressant chemicals, insect repellents, electromagnetic interference shielding materials, radio frequency interference shielding materials, heat-releasing phase change agents, fragrances, metallic reflector colloids, pigments, zeolites, dyes, fertilizers, sun blocking agents, pharmaceuticals, antimicrobial agents, anti-fungal agents, and sporicidal agents, or combinations thereof.

19. The method as claimed in claim 12, wherein the step of providing a substrate comprises providing a substrate comprising fibers, yarns, porous and non-porous textiles, membranes, metals, and natural and synthetic polymers, or combinations thereof.

20. The method as claimed in claim 12, wherein the step of providing a substrate comprises providing a textile, and wherein the step of treating a substrate comprises applying a solution of 10,12-pentacosadiynoic acid to the textile.

21. The method as claimed in claim 20, wherein the step of polymerizing comprises drying the treated substrate and exposing the treated substrate to UV radiation for a period sufficient to cause cross-linking of the 10,12-pentacosadiynoic acid.
